(19) United States
(12) Patent Application Publication
(10) Pub. No.: US 2013/0328813 A1
(43) Pub. Date: Dec. 12, 2013

(54) Unlocking Mechanism for a Touch Screen Device

(71) Applicant: Inputek Co., Ltd., Hsinchu County (TW)

(72) Inventors: Sheng Chang KUO, Hsinchu County (TW); Ming Hui HUNG, Hsinchu County (TW); Chi Chin CHEN, Hsinchu County (TW)

(21) Appl. No.: 13/914,726

(22) Filed: Jun. 11, 2013

Related U.S. Application Data
(60) Provisional application No. 61/658,243, filed on Jun. 11, 2012.

(51) Int. Cl. G06F 3/0488

(52) U.S. Cl. CPC G06F 3/0488
USPC 345/173

(57) ABSTRACT

A method for unlocking a touchscreen device comprises no involvement of pressing a physical button of the touchscreen device. Rather, it employs a pre-defined touchscreen area as the unlocking spot. The location and size of this unlocking spot can be redefined by a user. When this spot is touched by a finger, a counter will start to count numbers. When it passes a pre-defined number threshold, the activation signal will be sent to a micro control unit (MCU) to activate the MCU. In this way, the touchscreen device is unlocked. In addition, a power saving circuit is provided to execute such unlocking function and reduce power consumption.

The current application claims a priority to the U.S. Provisional Patent Application Ser. No. 61/658,243, filed on Jun. 11, 2012.

### FIELD OF THE INVENTION

The present invention relates to a system and a method for unlocking a locked touchscreen device. In particular, it relates to an unlocking mechanism with no involvement of pressing a button, but with touching a specified touchscreen spot for a pre-defined period of time.

### BACKGROUND OF THE INVENTION

A touchscreen is an electronic visual display device that a user can control through simple or multi-touch gestures by touching the screen with one or more fingers. Some touchscreens can also detect objects such as a stylus or ordinary or specially coated gloves. The user can use the touchscreen to react to what is displayed, and to control how it is displayed (for example by zooming in the text size).

The touchscreen enables the user to interact directly with what is displayed, rather than using a mouse, touchpad, or any other intermediate device. Touchscreen is a common component in a wide variety of different electronic devices, such as mobile phone, game console, all-in-one computer and tablet computer.

Touchscreen plays a prominent role in many of the aforementioned device. In comparison to the conventional keyboard and mouse system, touchscreen allows a more suitably intuitive or more accurate interaction by the user with the displayed contents.

The popularities of smartphones (e.g., iPhone), tablets (e.g., iPad), and many other types of information appliances have driven the acceptance and demand of common touchscreens to an even higher level. Moreover, touchscreens are also very popular in the medical field and in heavy industry, as well as in kiosks such as museum displays.

However, as touchscreen is usually a part of the display, and very often an inseparable part of the whole mobile or portable device, they are very easy to be activated by an inadvertent or accidental contact, which may lead to certain unwanted results. In this concern, most of the touchscreens would be automatically locked when not in use for a certain period of time. Additionally, in order to avoid activating a locked touchscreen device by accident, a specific unlocking mechanism is usually employed to control the locking/unlocking of a touchscreen.

Traditionally, such as for the popular iPhone, a physical button is provided on the device to perform the locking and unlocking functions. In order to unlock a touchscreen device, a user has to first press that physical button, and next perform the action of unlocking the touchscreen, usually by a specific gesture. In this manner, the user has to go through this two-step procedure in order to unlock a locked touchscreen. To many users, this procedure is nevertheless quite inconvenient.

For example, in a case when a user is reading a pretty long content (email, text, book chapter, etc.) that spans multiple pages, if the touchscreen is set to be always active, this may cause some unnecessary power consumptions. On the other hand, if the touchscreen is locked due to no active action for a period of time, the user would have to press the physical button first, and then activate the touchscreen, in order to see the content on the next page. In this situation, one possible solution would be to lock the touchscreen if it is not in use for a preset period of time; and to quickly and conveniently unlock the touchscreen with no need to press a physical button. And it would be even better if such unlocking process can be customized by the user to make it more personalized or more convenient.

Therefore, one primary objective of the present invention is to provide a convenient mechanism to unlock a touchscreen without the involvement of touching a physical button.

### BRIEF DESCRIPTION OF THE DRAWINGS

FIG. 1 is a schematic view of the present invention.

FIG. 2 is a schematic view with details of the detection unit of the present invention.

FIG. 3 is a schematic view of the unlocking process related device system of the present invention.

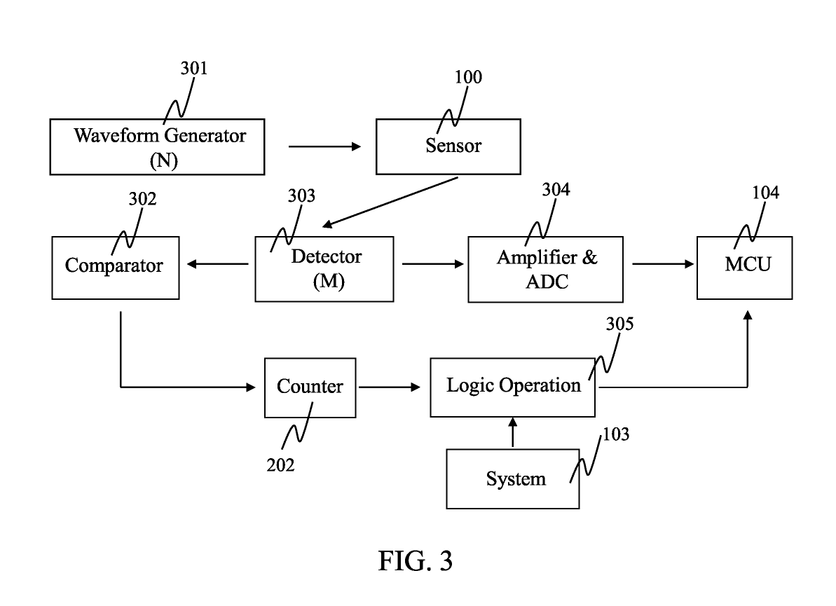

### DETAILED DESCRIPTION OF THE INVENTION

All illustrations of the drawings and descriptions of the embodiments are for the purpose of describing selected versions of the present invention and are not intended to limit the scope of the present invention.

The present invention has applied a more instinct manner to design the unlocking method. The following aspects were considered about the unlocking process of the current invention. The main purpose of the present invention is to provide an easy and convenient way to unlock the locked touchscreen panel. In this regard, the major issue the current invention needs to avoid is the unintended unlocking occurring by accident. In addition, the unlocking method should consider the issue of power saving.

Concerning the above aspects, the key issue would be to set up a specific manner to determine whether the user has the intention to unlock the device. In the present invention, the solution is to touch a specified area of the touchscreen. To be specific, there are two determinations needs to be made in order to understand the user's intention and make the final decision about whether unlocking the touchscreen. The first one is to check if the pre-defined specific area on the touchscreen has been touched. The second one is how long it has been touched, and whether the length of touching time has passed a pre-determined threshold. In this way, the proposed unlocking method could replace the need of a physical button on the touch screen device. The user can use the touch screen device in a more straightforward way instead of the conventional two step procedure. In addition, the pre-defined specificities about the location and length of time should be able to effectively eliminate the possibility that the device is unlocked by an accident.

Theoretically, in comparison to the approach with physical button involvement, the approach of using only the touchscreen to unlock a device could cause some unnecessary power consumption. Therefore, a power saving circuit has been designed to solve the issue.

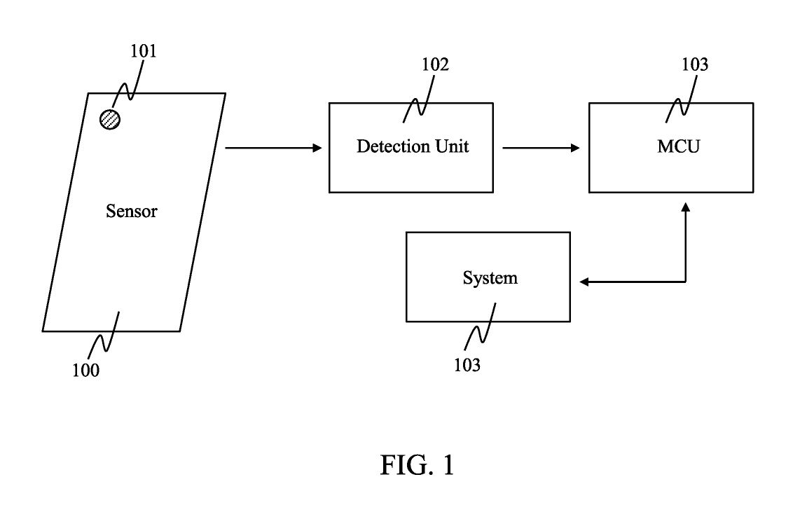

In reference to FIG. 1 that summarizes the general concept and basic design of the present invention, a specific area (unlocking spot) 101 of the touchscreen sensor 100 has been pre-defined. This includes both the spot's location and size. Its location can be anywhere on the touchscreen. Generally such location would be convenient for a user's finger to touch, and not easy to be hit by accident. But it should be noted that anywhere of a touchscreen can be defined as the spot, even if it is considered as inconvenient for a finger touch or prone to accidental touch, because the users can always change its location whenever he wants. Similarly, the size of the spot would be suggested as 2-3 rows and columns of sensor bars. It is true that the larger the spot size is (i.e., more sensor bars are “opened”), the more the standby power consumption is. However, for users' convenience, the spot size can be set as any size. There is no limitation on such size choice. Furthermore, this spot is usually predefined. However, various users (including the device manufacturers who use the disclosed method/system or the customers who use a device with the disclosed system) can always redefine or modify the location and size of this unlocking spot.

In addition to the specifications of the unlocking spot, the length of touching time is the other requirement that needs to be satisfied. The main purpose of this design is to differentiate a user's intention to unlock the touchscreen device from an accidental touch of that spot area. The rationale of such design is that usually the accidental touching is pretty short; not lasting a significant length of time. Therefore, via defining a necessary length of touching time, maybe through a few trial and error processes, a user can effectively define a length of time that effectively unlock the touchscreen only upon the user's intention. Usually, the length of time is set at 1 second. However, this is no limitation about how long this time should be. The user can set it as long as he wants. On the other hand, for a pre-defined length of time, a user can always redefine it or modify it, i.e., to customize it.

Also in reference to FIG. 1, when the aforementioned two requirements have been satisfied, an activation signal will go to the detection unit 102. This detection unit comprises the mentioned power saving circuit of the present invention. And through this detection unit, the signal will be sent to the micro control unit (MCU) 103. Eventually, the MCU will be activated and thus, the touchscreen has been unlocked. Sometimes, the MCU would activate the entire hardware system of the touchscreen device, such as smartphone or tablet. On the other hand, the MCU can be activated (unlocked) by certain hardware system without the initiation of touching the unlocking spot. This has also been illustrated in FIG. 1. For example, in a touchscreen device like iPad, a magnetic sensor in the hardware system, when activated, can wake up the system, and then wake up the MCU. Thus unlock the touchscreen device.

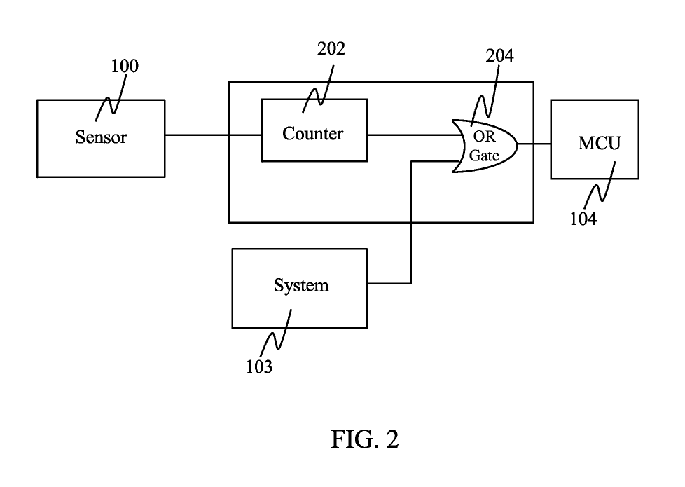

In reference to FIG. 2, the inner detail of the detection unit has been shown. It comprises a counter and a logic gate, which is an OR gate. When the pre-defined unlocking spot has been touched, the signal from the sensor 100 will be first transferred to the input side of the detection unit 102. Next the signal will be transferred to the counter 202. The activated counter will start to count. In this context, the count number depends on the length of touching time by a user. When the count reaches a certain number, an activation signal will be transferred to activate the MCU 104 via the OR gate 204. The OR gate 204 is a function to increase the possible approaches to wake up the MCU 104, thus to unlock the touchscreen device. Within the device hardware system, there could be other sensor(s) implemented to wake up the MCU. For example, in the iPad and other tablet touchscreen device, a magnetic sensor has been installed to wake up the system at certain circumstances. And then the activation signal will be sent to the MCU via the OR gate 204 to activate the MCU. In this manner, it has provided another way to unlock the touchscreen device even without touching the unlocking spot.

In a conventional touchscreen device, the basic mechanism is like this. N bits of waveform generator transmits analog signal to a sensor, and M bits detector receives the signal from the sensor. Via the amplifier and analog to digital converter (ADC), the signal is transferred to the MCU to unlock the touchscreen device and calculate the X, Y coordinates. In the sleep (locking) mode, almost all subsystem is power down for the best power saving. In the current invention, in the locking mode, system sends an interrupt (INT) to a logic circuit to disable MCU. Then the MCU will disable the amplifier, ADC and most parts of the detector and waveform generator. When a comparator 302 detects a touching signal from the unlocking spot for a certain period of time via the detector 303, the counter 202 will count numbers. When certain count numbers (length of touching time) is reached, a logic operation 305 will send an INT to MCU to wake up MCU. When MCU is enabled, the touch sub-system N-bits of waveform generator 301, M bits of detector 303 and amplifier and ADC 304 will be enabled, while comparator 302, counter 202 and logic operation 305 will be disabled.

To be specific, the following steps will be executed to unlock a touchscreen device. 1) The firmware code defines the unlocking spot. 2) Hardware uses a very low frequency clock rate (<100 Hz) to sweep the sensing line (defined by firmware). 3) If a finger is touching, a counter starts to count numbers to make sure it is a real unlocking demand. 4) Enable the LCD and touchscreen, and the firmware jumps to normal operation mode by sweeping all sensor bars, and clock rate backs to normal clock rate (>1 KHz). In addition, in a locking mode, a comparator will start to detect whether the specific area is touched or not. When the comparator is high (touchscreen is touched), counter will start to count. If the comparator high period is smaller than the pre-set counting time, this is an accidental touch (unwanted touch), counter will be cleared and waits for next comparator high. If the comparator high period is large than a pre-set counting time, MCU will send a signal to wake up system and wake up itself.

In the present invention, the power is saved as the following. In the locking mode, most of the units, such as amplifier, ADC and MCU will go to sleep. Only one or a few waveform generators and one or a few detectors are active, in order to save power. Additionally, the unlocking touch location is limited to avoid unwanted touching wake up.

Although the invention has been explained in relation to its preferred embodiment, it is to be readily understood that many other possible modifications and variations can be made without departing from the spirit and scope of the invention as hereinafter claimed.

What is claimed is:

1. A method for unlocking a touchscreen device, comprising
defining an area on a touchscreen as an unlocking spot;
said unlocking spot comprising a location and a size;
defining a threshold of length of time;
determining whether said unlocking spot is touched;
counting a length of time when said unlocking spot is touched;
determining whether said length of time is equal to or larger than said threshold of length of time;
sending a first signal to a detection unit when said length of time is equal or larger than said threshold of length of time;
sending an activation signal to a micro control unit (MCU) of said touchscreen device;
activating said MCU; and
unlocking said touchscreen device.

2. The method for unlocking a touchscreen device of claim 1, comprising
redefining said location of said unlocking spot; and
redefining said size of said unlocking spot.

3. The method for unlocking a touchscreen device of claim 1, comprising
redefining said threshold of length of time.

4. The method for unlocking a touchscreen device of claim 2, comprising
redefining said size of said unlocking spot as 2 rows and 2 columns of sensor bars on said touchscreen, or redefining said size of said unlocking spot as 3 rows and 3 columns of sensor bars on said touchscreen.

5. The method for unlocking a touchscreen device of claim 3, comprising
redefining said threshold of length of time as 1 second.

6. The method for unlocking a touchscreen device of claim 1, comprising
counting numbers by a counter;
sending a second signal to a logic operation when a counted number passes a pre-defined number threshold; and
transferring said second signal through said logic operation; and
generating said activation signal.

7. The method for unlocking a touchscreen device of claim 6, comprising
said logic operation being an OR gate.

8. The method for unlocking a touchscreen device of claim 1, comprising
generating a third signal from a hardware system of said touchscreen device;
transferring said third signal through an OR gate; and
sending a second activation signal to said MCU.

9. The method for unlocking a touchscreen device of claim 1, comprising
determining the state of said touchscreen device;
sending a first interrupt when said state is a locking state;
disabling said MCU; and
disabling an amplifier and an analog to digital converter (ADC).

10. The method for unlocking a touchscreen device of claim 1, comprising
determining the state of said touchscreen device;
sending a second interrupt when said state is an unlocking state;
activating said MCU; and
activating an amplifier and an analog to digital converter (ADC).

11. The method for unlocking a touchscreen device of claim 9, comprising
sweeping said unlocking spot with a clock rate of a frequency less than 100 Hz.

12. The method for unlocking a touchscreen device of claim 10, comprising
sweeping all sensor bars of said touchscreen device with a clock rate of a frequency greater than 1 KHz.

13. The method for unlocking a touchscreen device of claim 1, comprising
detecting by a comparator whether said unlocking spot being touched; and
said comparator being high when said unlocking spot is touched by a finger.

14. A method for unlocking a touchscreen device, comprising
defining an area on a touchscreen as an unlocking spot;
said unlocking spot comprising a location and a size;
defining a threshold of length of time;
determining whether said unlocking spot is touched;
counting a length of time when said unlocking spot is touched;
determining whether said length of time is equal to or larger than said threshold of length of time;
sending a first signal to a detection unit when said length of time is equal or larger than said threshold of length of time;
sending an activation signal to a micro control unit (MCU) of said touchscreen device;
activating said MCU;
unlocking said touchscreen device;
generating a third signal from a hardware system of said touchscreen device;
transferring said third signal through an OR gate; and
sending a second activation signal to said MCU.

15. The method for unlocking a touchscreen device of claim 14, comprising
redefining said location of said unlocking spot;
redefining said size of said unlocking spot; and
redefining said threshold of length of time.

16. The method for unlocking a touchscreen device of claim 15, comprising
redefining said size of said unlocking spot as 2 rows and 2 columns of sensor bars on said touchscreen, or redefining said size of said unlocking spot as 3 rows and 3 columns of sensor bars on said touchscreen; and
redefining said threshold of length of time as 1 second.

17. The method for unlocking a touchscreen device of claim 14, comprising
counting numbers by a counter;
sending a second signal to a logic operation when accounted number passes a pre-defined number threshold;
transferring said second signal through said logic operation;
generating said activation signal; and
said logic operation being an OR gate.

18. The method for unlocking a touchscreen device of claim 14, comprising
determining the state of said touchscreen device;
sending a first interrupt when said state is a locking state;
disabling said MCU;
disabling an amplifier and an analog to digital converter (ADC); and
sweeping said unlocking spot with a clock rate of a frequency less than 100 Hz.

19. The method for unlocking a touchscreen device of claim 14, comprising
determining the state of said touchscreen device;
sending a second interrupt when said state is an unlocking state;
activating said MCU;
activating an amplifier and an analog to digital converter (ADC); and
sweeping all sensor bars of said touchscreen device with a clock rate of a frequency greater than 1 KHz.

20. The method for unlocking a touchscreen device of claim 14, comprising
detecting by a comparator whether said unlocking spot being touched; and
said comparator being high when said unlocking spot is touched by a finger.
